(19) United States
(12) Patent Application Publication
(10) Pub. No.: US 2006/0235345 A1
(43) Pub. Date: Oct. 19, 2006

(54) Massaging Applicance for Baths

(76) Inventor: Hristo IVANOV, Rousse (BG)

Correspondence Address: Nikolay Radoslavov, 128 8th Primorski Polk, Blvd., Office 12, Varna, 90002, BG

(21) Appl. No.: 10/532,496

(22) PCT Filed: Oct. 21, 2003
(86) PCT No.: PCT/BG03/00037

§ 371 Date: Apr. 25, 2005

(30) Foreign Application Priority Data
Oct. 29, 2002 (BG) 107232

(51) Int. Cl. A61H 7/00

(52) U.S. Cl. 601/138; 601/136; 601/154

(57) ABSTRACT

The disclosed back scrubbing device for use without hands can be installed in baths and/or fitness centers as well as in sport clubs are similar facilities. The device allows the application of a detergent thereon and cleaning while massaging the body. The applied massaging pressure can be controlled individually by the pressure the user applies against the device. The device comprises a three-dimensional main body with upper and lower plane surfaces, a flat back with furrows (rigides or grooves for dropping off water) and a convex or doubleconvex front side having protrusions, the device further comprises connecting elements (tubular guide) for adjustably connecting it to a vertical rod or bar and fixing means for fixing it to different positions along the rod.

### TECHNICAL FIELD

The invention relates to a bath appliance, which could be implemented when equipping baths and/or fitness centers, as well when equipping sports clubs and other similar facilities.

### BACKGROUND ART

An appliance is known, designated to human body wipe, consisting of a textile usually of the bath robe type, edged by a braid and holders attached to the edges. Usually the textile is approximately shaped as an elongate rectangle. An elliptic form or other elongate forms are also possible. With the above object a soap or another detergent can be put on the body and the body to be subjected to a massage by manually pressing and moving of the appliance along the human body surface. Usually the appliance is held by both hands applied to the holders. Difficulties are arising when the appliance is used by a person who for different reasons cannot use the both hands and from another side the pressing when manually performed, is not enough intensive in order a good massage to be achieved. The form of the object makes impossible all parts of the human body to be reached. The amortization of the appliance is too fast.

An appliance of another type is also known, the appliance having the similar designation and consisting of a basic element in the form of elongate broad-nosed handle with a brush fitted to the end. Only one hand could be applied when operating this appliance, but the operation is tiresome and a good massage of the body can not be achieved. The appliance is subjected to a fast amortization.

### SUMMARY OF THE INVENTION

The invention seeks to provide a bath appliance which can enable the detergent to be put on the body as well a massage of the body to be performed without using the hands and which can allow a personal control with respect of the pressing force, enabling also an easy maintenance and amortization reducing.

In accordance with the invention, this object is accomplished in a bath appliance, comprising a basic element, performed as a volume body, having an upper and a lower plains, flat back, provided with furrows and a convex front side, embossed so as saliences to be formed. Connecting devices are also provided in order the volume body to be mounted on a support.

It is recommended the convex front side of the volume body to represent a part of a cylindrical convex surface or a part of a double-convex surface.

The saliences of the front side of the volume body are formed with round tops.

On the opposite edges of the flat back of the volume body two strips are cut out in order stages to be formed.

It is recommended double-armed grooves to be formed on the both upper and lower plains of the volume body.

The basic element can be performed both as a compact body or as a compact core fitted with a cover embossed with saliences and furrows.

It is also possible the basic element to be carried out as a frame with a cover fitted thereto, which cover represents the outward appearance with saliences and furrows.

The material of which the basic element is made shall not absorb an water and shall posses a limited deformability.

In order a hygiene to be maintained it is recommended a case to be disposed on the front side of the basic element.

The connecting devices of the basic element are performed as bushes built in both the upper and the lower plains of basic element.

It is also possible the connecting devices of the basic element to be performed as an internal mounted pipe.

In order to facilitate the operation, the volume body is mounted by means of the connecting devices so as a possibility to be provided to be moved lengthwise of a rod-shaped bearer.

The rod-shaped bearer can be performed as a compact rod, a bar or a pipe with an optional cross section form.

Fixing elements are fitted to the rod-shaped bearer.

The fixing elements are comprising at least a pipe element fitted with a bottom.

It is recommended bores to be spaced apart from one another lengthwise of the rod-shaped bearer. By means of screw connection the connecting devices of the basic element can be fixed to at least one of the bores.

It is also possible the connecting devices of the basic element to be fitted to the rod-shaped bearer by means of a sliding connection.

The bath appliance formed in accordance with the invention has a number of advantages. The putting of a detergent and the performing of a massage at the same time can be carried out without using the hands. The user of the appliance is in a position to control and to dose the pressing force when performing the massage. As a result a massage of good quality of all body parts can be obtained since the basic element could be moved lengthwise of the rod-shaped bearer. The appliance can be used also by children, performing bathing or massage, without being accompanied by adults. The hands fatigue, due the difficult position is avoided. Easy maintenance and cleaning is achieved. Retarded amortization i.e. a long term of the appliance use.

### DESCRIPTION OF THE FIGUERS IN THE DRAWINGS

The invention will now be described by way of examples and with reference to the accompanying in which:

FIG. 1 is a perspective view of a bath appliance, in accordance with the invention;

FIG. 2 is A-A view from FIG. 1;

FIG. 3 is B-B view from FIG. 1;

FIG. 4 is a perspective view of a case, according to the invention;

FIG. 5 is C-C cross-sectional view from FIG. 1;

FIG. 6 is C-C cross-sectional view of a variant embodiment of the volume body;

FIG. 7 is a perspective view of the bath appliance in accordance with a variant embodiment illustrating the possibility to move the basic element lengthwise of the rod-shaped bearer;

FIG. 8 illustrates a fixing element of the appliance in accordance with a variant embodiment.

### DETAILED DESCRIPTION OF THE EMBODIMENTS

In accordance with the examples shown of the invention embodiments, the bath appliance comprises a basic element, formed as a volume body 1, having upper 2 and lower 3 plains, flat back 4, provided with furrows 5 and a generally convex front side 6. The surface 7 of the front side 6 is embossed so as saliences 8 to be formed. To the volume body 1 connecting devices 9 are fitted in order a connection to a support to be provided. The saliences 8 on the front side 6 of the volume body 1 are with round tops and have a form, for example, of a conical, pyramidal or semi-spherical kind. Said forms are not limiting insofar any chosen form of the salience 8 can result in a realization of the invention. The choice of the form depends, in this case, on the technological equipment chosen or available. The convex form of the front side 6 of the volume body 1 can be formed as a part of a cylindrical convex surface or as a part of double-convex surface, depending on the equipment used and the desired outward appearance.

On the both opposite lengthwise edges of the flat back 4 of the volume body 1 strips are cut out so as the stage 10 to be formed in order to enable the attachment of the case 11 disposed on the front side 6 of the volume body 1. The use of the case 11 is recommended in order a hygiene to be maintained. Both the upper 2 and the lower 3 plains of the volume body 1 are provided with the two-armed groove 12 in order the case 11 to be secured. The case 11 shall be made of a flexible material allowing the user to feel the contact to the saliences 8 of the front side 6 of the basic element 1. Recommended materials are linen, silk, raw silk as well as each material being enough strong and allowing a hygiene to be maintained.

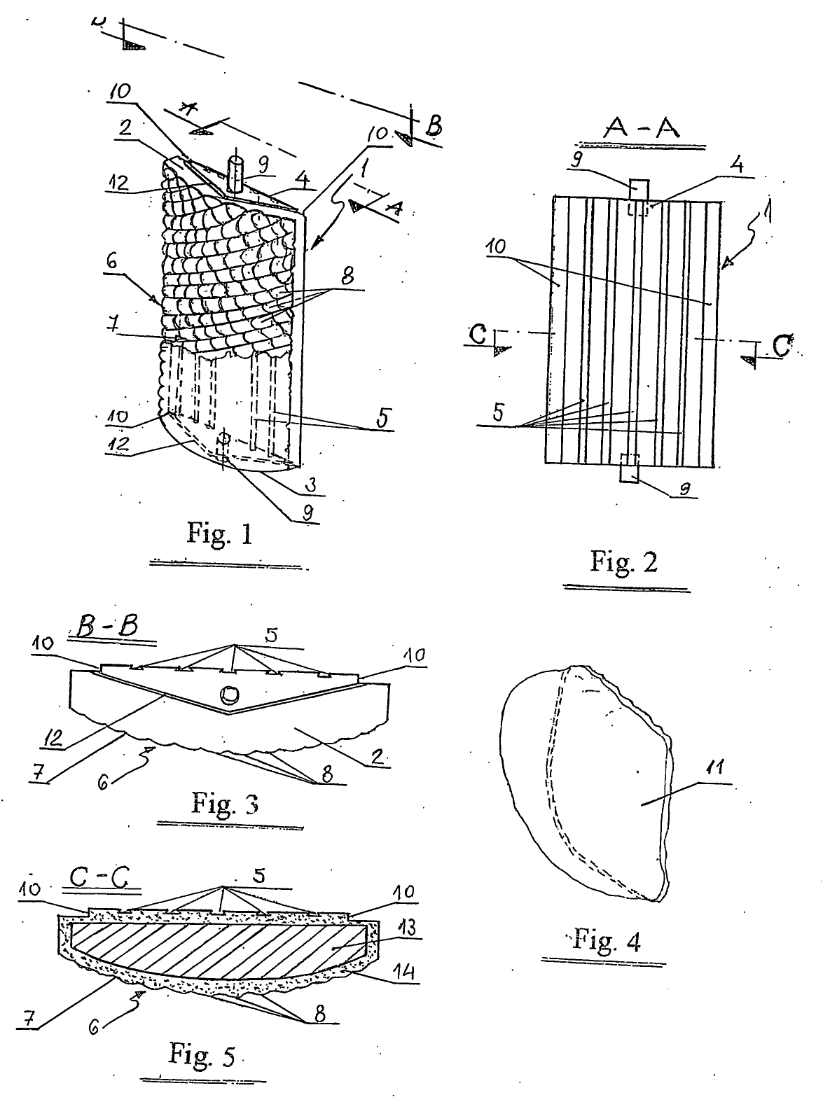

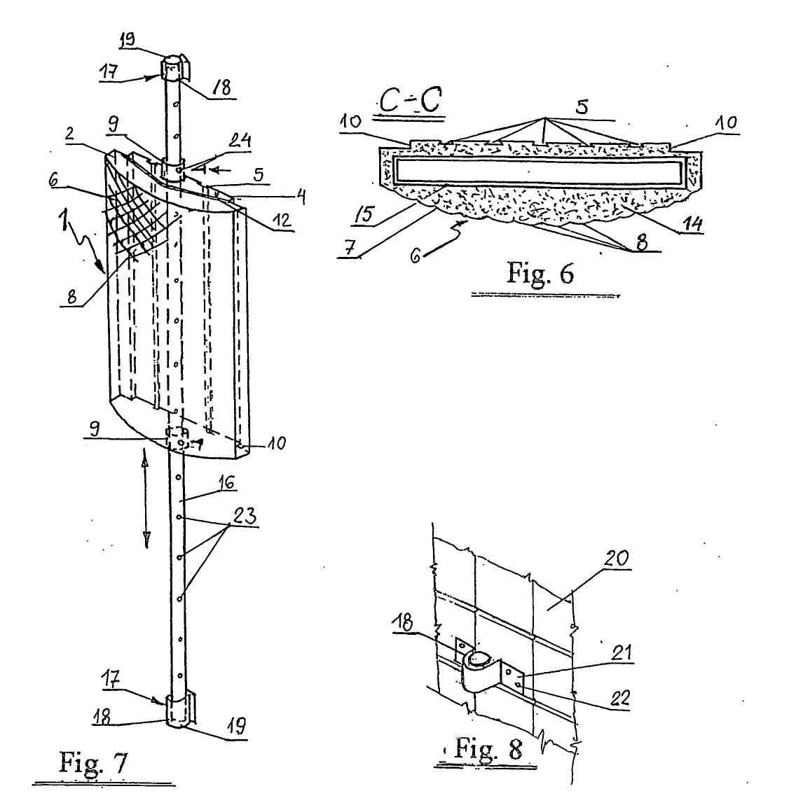

The connecting devices 9 of the basic element—volume body 1 can be realized in different ways. According to the variant embodiment as shown in FIGS. 1 and 2, the connecting devices 9 are carried out as bushes built in the upper 2 and the lower 3 plains of the basic element 1. It is also possible the connecting devices 9 to be realized as an internally disposed pipe element (not shown).

The basic element-volume body 1 can be carried out as a compact body as shown in FIG. 3. According to a variant embodiment the basic element may be formed as a compact core 13 fitted with a cover 14 provided with saliences 8 and furrows 5. According to a further variant embodiment the basic element 1 consists of a frame 15, provided with the cover 14, representing the outward appearance with saliences 8 and furrows 5.

The basic element-volume body 1 is recommended to be made of a material which does not absorb an water and has a limited deformability. This requirement refers also to the cover 14, fitted to the frame 15 or to the internal core 13 according to the variant embodiments. Recommended are materials of the kind of a rubber, a raw rubber, plastics and similar materials.

According to the invention, the volume body 1 is mounted by means of connecting devices 9 and a possibility is provided to be moved lengthwise of the rod-shaped bearer 16 as shown in FIG. 7. The rod-shaped bearer 16 may be of the kind of a compact rod, a bar or a pipe element. In the drawings a pipe element with a cylindrical cross section is shown but the form of the cross section may be optional and the concrete form may depend on factors as a load ability and a visual effect. The rod-shaped bearer 16 is fitted with fixing elements 17 as shown in FIGS. 7 and 8. The fixing elements 17 are consisting of at least a pipe element 18 and a bottom 19. According to the embodiment shown in FIG. 7 the rod-shaped bearer 16 is supported by said bottom 19. The fixing elements 17 are mounted by known means, usually by means of a screw connection to a supporting structure, for example an wall or a similar structure. It is possible also the fixing elements to be carried out in the form of the plates 21 secured to the supporting structure by known means, for example by means of a screw connection 22.

According to a variant embodiment bores 23 are spaced apart from one another lengthwise of the rod-shaped bearer 16. To at least one of the bores 23 by means of a screw connection 24 the connecting devices of the basic element 1 are attached. Thus a possibility is provided to move the basic element 1 lengthwise of the rod-shaped bearer 16.

According to the invention an option is provided the connecting devices 9 of the basic element 1 to be mounted on the rod-shaped bearer 16 by means of sliding connection (not shown). The sliding connection is of a known kind, for example a screw fixation.

Implementation of the Invention

The bath appliance can be used after being mounted in the room on a supporting structure 20, for example an wall, a column or of the similar kind. If the basic element 1 is mounted on a rod-shaped bearer 16, then a fixation of the fixing elements 17 to said supporting structure 20 should firstly be performed. When usually used the rod-shaped bearer 16 is to be vertically mounted. Depending on the concrete implementation the rod-shaped bearer 16 can be disposed in a different position. Next the case 11 is to be fitted to the front side 6 of the volume body 1. For the safe securing of the case 11 the stages 10 on the flat back 4 are to be used. For the same purpose the groove 12 disposed on the upper 2 and lower 2 plains of the volume solid 1 shall be used. The relevant height is to be set by means of either sliding connections or the bores 23 disposed lengthwise of the rod-shaped bearer 16. After putting the detergent the user can perform a massage by pressing the relevant part of his body to the bath appliance. The furrows 5 on the flat back 4 of the basic element 1 enable the sew water to be lead away.

1. A bath appliance, comprising a basic element, formed as a volume body, characterised in that the volume body (1) has an upper (2) and a lower (3) plains, flat back (4), fitted with the furrows (5) and a front side (6) having a generally convex form and a surface (7) embossed so as the saliences (8) to be formed, whereas on the volume body (1) the connecting devices (9) are mounted for connecting to a support.

2. A bath appliance according to claim 1, characterised in that the convex form of the front side (6) of the volume body (1) is a part of a cylindrical convex surface.

3. A bath appliance according to claim 1, characterised in that the convex form of the front side (6) of the volume body (1) is a part of a double-convex surface.

4. A bath appliance according to any one of claims 1 to 3, characterised in that the saliences (8) of the front side (6) of the volume body (1) have a form with a round top.

5. A bath appliance according to any one of claims 1 to 4, characterised in that on the both opposite edges of the flat back (4) of the volume body (1) strips are cut out to form the stage (10).

6. A bath appliance according to claim 5. characterised in that a two-armed groove (12) is formed on both the upper (2) and the lower (3) plains of the volume body (1).

7. A bath appliance according to any one of claims 1 to 6, characterised in that the basic element (1) is a compact body.

8. A bath appliance according to any one of claims 1 to 6, characterised in that the basic element (1) is formed as a compact core (13) fitted with a cover (14) with saliences (8) and furrows (5).

9. A bath appliance according to any one of claims 1 to 6, characterised in that the basic element (1) is formed as a frame (15), with the cover (14) mounted thereon, representing its outward appearance with saliences (8) and furrows (5).

10. A bath appliance according to any one of claims 1 to 8, characterised in that the basic element (1) is made of a material which does not absorb an water and has a limited deformability.

11. A bath appliance according to any one of claims 1 or 10, characterised in that the front side (6) of the volume body (1) is fitted with the case (11).

12. A bath appliance according to any one of claims 1 to 10, characterised in that the connecting devices (9) of the basic element (1) are carried out as bushes built in both the upper (2) and the lower (3) plains of the volume body (1).

13. A bath appliance according to any one of claims 1 to 10, characterised in that the connecting devices (9) of the basic element (1) are carried out as an internally mounted pipe element.

14. A bath appliance according to any one of claims 1 to 13, characterised in that the volume body (1) is mounted by means of the connecting devices (9) and a possibility is provided the volume body (1) to be moved lengthwise of the rod-shaped bearer (16).

15. A bath appliance according to claim 14, characterised in that the rod-shaped bearer (16) is of the kind of a compact rod, a bar or a pipe element.

16. A bath appliance according to claim 14 or 15, characterised in that the rod-shaped bearer (16) has a cross section with a freely chosen form.

17. A bath appliance according to any one of claims 14 to 16, characterised in that the rod-shaped bearer (16) is fitted with fixing elements (17).

18. A bath appliance according to claim 17, characterised in that the fixing elements (17) are comprising at least a pipe element (18) and a bottom (19).

19. A bath appliance according to any one of claims 14 to 18, characterised in that bores (23) are spaced apart from one another lengthwise of the rod-shaped bearer (16) and on at least one of the bores (23) by means of a screw connection (24) are mounted the connecting devices (9) of the volume body (1).

20. A bath appliance according to any one of claims 14 to 18, characterised in that the connecting devices (9) of the volume body (1) are attached to the rod-shaped bearer (16) by means of a sliding connection.
